(19) United States
(12) Patent Application Publication
(10) Pub. No.: US 2025/0260139 A1
(43) Pub. Date: Aug. 14, 2025

(54) CYLINDRICAL BATTERY SUITABLE FOR HIGH-SPEED PRODUCTION AND ASSEMBLY PROCESS THEREOF

(71) Applicant: LANJING NEW ENERGY (JIAXING) CO., LTD., Jiaxing (CN)

(72) Inventors: Ju WANG, Jiaxing (CN); Shunan FENG, Jiaxing (CN); Chuntai GUO, Jiaxing (CN); Wei HE, Jiaxing (CN); Yizhi YANG, Jiaxing (CN)

(73) Assignee: LANJING NEW ENERGY (JIAXING) CO., LTD., Jiaxing (CN)

(21) Appl. No.: 19/193,330

(22) Filed: Apr. 29, 2025

Related U.S. Application Data
(63) Continuation of application No. PCT/CN2023/082163, filed on Mar. 17, 2023.

(30) Foreign Application Priority Data
Nov. 30, 2022 (CN) 202211519901.2

(51) Int. Cl. H01M 50/536; H01M 10/04; H01M 50/107; H01M 50/152; H01M 50/184; H01M 50/186; H01M 50/193; H01M 50/538; H01M 50/559; H01M 50/567; H01M 50/627

(52) U.S. Cl. CPC H01M 50/536; H01M 10/0431; H01M 50/107; H01M 50/152; H01M 50/184; H01M 50/186; H01M 50/193; H01M 50/538; H01M 50/559; H01M 50/567; H01M 50/627

(57) ABSTRACT

A cylindrical battery suitable for high-speed production includes a case assembly, the case assembly comprises a case; the case is a U-shaped structure; a jelly roll member is provided in the case; two ends of the jelly roll member are respectively provided with tabs; the tab at one end of the jelly roll member is welded with a first current collector; the tab at the other end of the jelly roll member is welded with a second current collector; the first current collector is closely attached to a bottom end of the U-shaped structure of the case; the second current collector is provided at an opening of the U-shaped structure of the case; a side of the second current collector away from the jelly roll member is provided with a cover plate; and the second current collector, the case and the cover plate are welded to form an integrated structure.

### CROSS-REFERENCE TO RELATED APPLICATIONS

This application is a continuation of International Patent Application No. PCT/CN2023/082163 with a filing date of Mar. 17, 2023, designating the United States, now pending, and further claims priority to Chinese Patent Application No. 202211519901.2 with a filing date of Nov. 30, 2022. The content of the aforementioned applications, including any intervening amendments thereto, is incorporated herein by reference.

### TECHNICAL FIELD

The present disclosure belongs to the technical field of batteries, relates to lithium battery structures, and particularly relates to a cylindrical battery suitable for high-speed production and an assembly process thereof.

### BACKGROUND

At present, the cover plate of the conventional cylindrical battery has a complex structure. When the cap as a positive electrode and the case as a negative electrode are assembled into a battery module, the positive electrode and the negative electrode are electrically connected from two ends of the cylindrical battery. This is not conductive design and welding of a busbar of the external module. Besides, the power performance of the battery cannot be ensured for few tabs. As the cylindrical size increases, the existing tab or structure cannot achieve rapid heat transfer. The existing structure is sealed by a roll groove in most conditions. The roll groove at least takes up a space of 2-3 mm to affect the space utilization and energy density of the cell. The whole structure suffers the low welding efficiency, high equipment investment cost, complicated production process, and poor welding stability, with the welding quality not detected. Meanwhile, the laser penetration welding or ultrasonic torque welding has the low efficiency, generates the welding dust easily, and cannot guarantee the welding quality. In the battery sealing process, the liquid injection sealing pin is to be cleaned in welding for an electrolyte residue, thus affecting the sealing quality to cause liquid leakage.

### SUMMARY OF PRESENT INVENTION

In view of shortages in the prior art, the present disclosure provides a cylindrical battery suitable for high-speed production and an assembly process thereof, to solve problems of low assembly efficiency, poor heat transfer property, low welding efficiency, liquid leakage and the like of the battery in the prior art.

In order to solve the above technical problems, the present disclosure adopts the following technical solutions: A cylindrical battery suitable for high-speed production includes a case assembly, the case assembly includes a case; the case is a U-shaped structure; a jelly roll member is provided in the case; two ends of the jelly roll member are respectively provided with tabs; a tab at one end of the jelly roll member is welded with a first current collector; a tab at the other end of the jelly roll member is welded with a second current collector; the first current collector is closely attached to a bottom end of the U-shaped structure of the case; the second current collector is provided at an opening of the U-shaped structure of the case; a side of the second current collector away from the jelly roll member is provided with a cover plate; the second current collector is welded with the case and the cover plate to form an integrated structure; a liquid injection hole is formed in a center of a surface of the first current collector; first four L-shaped punched holes are formed around the liquid injection hole; a first central boss is provided around the liquid injection hole; a second central boss is provided at a center of a surface of the second current collector; second four L-shaped punched holes are formed around the second central boss; and a flange in an opposite direction to the second central boss is provided at an edge of the second current collector. The liquid injection hole is mainly configured to facilitate location of the first current collector with a polar pillar in a central hole, and realize electrical connection through pressing of a blind rivet. Meanwhile, the liquid injection hole also serves as a hole for injecting an electrolyte.

Further, an end of the case closely attached to the first current collector is provided with the central hole; the polar pillar is provided in the central hole; the polar pillar penetrates through the central hole; a through hole is formed in a center of the polar pillar; a step is provided in the through hole; an insulating element is provided between the polar pillar and the case; a first sealing ring is provided between the insulating element and the polar pillar; and a second sealing ring is provided between the first sealing ring and an end of the polar pillar away from the insulating element. The first current collector is provided with the first central boss and the liquid injection hole, and the through hole is formed in the polar pillar, such that the electrolyte is injected conveniently, and the first central boss of the first current collector is connected to the through hole by pull riveting. This sealing manner is simple and efficient.

Further, the first and second four L-shaped punched holes each include a long edge parallel to a long edge of an adjacent L-shaped punched hole, and a short edge parallel to a short edge of another adjacent L-shaped punched hole; an included angle between two edges of each of the first four L-shaped punched holes points to the liquid injection hole; and an included angle between two edges of each of the second four L-shaped punched holes points to the second central boss. The L-shaped punched hole is mainly configured to adapt to heights after the first current collector and the second current collector are respectively welded with the tabs of the cell, absorb the electrolyte, and eliminate a height tolerance of the jelly roll member. Bottoms of the four L-shaped punched holes enclose a weak conductive area. In response to an excessive external current, the weak conductive area is fused, thereby improving safety of the core.

Further, the second central boss is a tapered structure; the second central boss is inserted into a central hole of the jelly roll member; and an outer side of the flange of the second current collector is attached to an inner wall of the case and the cover plate and formed into the integrated structure with the inner wall of the case and the cover plate by vertical laser welding. This improves welding efficiency. The second central boss is mainly inserted into the jelly roll member for location.

Further, the liquid injection hole of the first current collector is sealed by the blind rivet; and the polar pillar is fixed on the case through the blind rivet. The polar pillar is provided with the through hole, and employs a combined connection scaling structure of the sealing rings and the blind rivet. The blind rivet makes the first central boss of the first current collector closely attached to an edge of the through hole to realize electrical connection, and further prevents poor welding for the electrolyte residue in welding using the liquid injection sealing pin, thereby improving a sealing pass rate.

Further, a locating step is provided at an axial edge of a surface of the cover plate; a periphery of the cover plate lapped with the case is thinned; a thinned thickness of the periphery of the cover plate is 0.5 times an original thickness of the periphery of the cover plate; and an explosion-proof snick formed by combining a circular hole with three trailing shapes is provided at a center of the cover plate. Through the thinned design at the periphery of the cover plate for cooperating with the current collector and the case, the cover plate, the current collector and the case can be welded together with less laser welding energy to realize sealing and electrical connection. This omits one welding process. The vertical galvanometric laser circumferential welding has higher efficiency than the side-rotating circumferential welding. This lowers the cost, improves the efficiency, reduces the laser welding energy and the welding defect, and improves the welding yield. With the explosion-proof snick of the cover plate, in response to failure of the cell, a valve is opened conveniently, and a height required to open the valve is reduced.

Further, the jelly roll member is one of a multi-tab jelly roll, a full-tab jelly roll, and a cut-and-stacked tab jelly roll.

Further, the sealing rings are made of a rubber material. The sealing rings made of the rubber material have desirable sealing performance within an operating pressure range and a certain temperature range, and can automatically improve the sealing performance as a pressure increases. These sealing rings have a stable coefficient of friction, strong resistance to corrosion, a simple structure, convenient use and maintenance, and a longer service life.

An assembly process of the cylindrical battery suitable for high-speed production includes the following steps:
S1, shaping the tabs of the wound jelly roll member, such that the tabs on the jelly roll member are closely attached in a planar state;
S2, respectively welding the tabs of the jelly roll member with the first current collector and the second current collector by laser to from a welded structure;
S3, inserting the welded structure into the case from the opening of the case;
S4, pressing the cover plate at the opening of the case for the vertical laser welding, and sealing the cover plate, the second current collector and the case together by melting, thereby forming electrical connection;
S5, performing liquid injection through the central hole and the liquid injection hole; and
S6, mounting a sealing ring on the polar pillar, and performing pull riveting with a blind rivet for sealing.

Compared with the prior art, the present disclosure has the following beneficial effects:
1. According to the present disclosure, the cover plate, the case and the second current collector are welded integrally and vertically, such that a positive electrode and a negative electrode are guided to a same side, thereby facilitating design and welding of the current collector of the module or system, improving the production efficiency, and lowering the manufacturing cost. The “L”-shaped through hole structure punched in the first current collector and the second current collector can absorb the electrolyte and eliminate the height tolerance of the jelly roll member. Through the thinned design at the periphery of the cover plate for cooperating with the current collector and the case, the cover plate, the current collector and the case can be welded together with less laser welding energy to realize sealing and electrical connection. This lowers the cost, and improves the efficiency. With the explosion-proof snick of the cover plate, in response to the failure of the cell, the valve is opened conveniently, and the height required to open the valve is reduced.
2. According to the present disclosure, the battery exhibits strong overcurrent capability to support the high-rate charging and discharging, and exhibits excellent heat dissipation to improve the fast-charging cycle life. Moreover, the battery is simple in assembly, applicable to high-speed manufacturing, and cost-effective.
3. According to the present disclosure, the polar pillar is provided with the through hole, and employs the combined connection sealing structure of the sealing rings and the blind rivet. The blind rivet makes the first central boss of the first current collector closely attached to the edge of the through hole to realize the electrical connection. Therefore, the present disclosure achieves the better sealing effect, and improves the sealing pass rate.

### BRIEF DESCRIPTION OF THE DRAWINGS

FIG. 1 is a schematic sectional view of a cylindrical battery suitable for high-speed production according to the present disclosure;

FIG. 2 is an exploded view of a cylindrical battery suitable for high-speed production according to the present disclosure;

FIG. 3 is a schematic sectional view of a case assembly of a cylindrical battery suitable for high-speed production according to the present disclosure;

FIG. 4 is a schematic sectional view of a cylindrical battery suitable for high-speed production according to the present disclosure;

FIG. 5 is a schematic structural view of a first current collector of a cylindrical battery suitable for high-speed production according to the present disclosure;

FIG. 6 is a top view of a first current collector of a cylindrical battery suitable for high-speed production according to the present disclosure;

FIG. 7 is a front view of a first current collector of a cylindrical battery suitable for high-speed production according to the present disclosure;

FIG. 8 is a schematic structural view of a second current collector of a cylindrical battery suitable for high-speed production according to the present disclosure;

FIG. 9 is a top view of a second current collector of a cylindrical battery suitable for high-speed production according to the present disclosure;

FIG. 10 is a front view of a second current collector of a cylindrical battery suitable for high-speed production according to the present disclosure;

FIG. 11 is a schematic structural view of a cover plate of a cylindrical battery suitable for high-speed production according to the present disclosure;

FIG. 12 is a top view of a cover plate of a cylindrical battery suitable for high-speed production according to the present disclosure;

FIG. 13 is a front view of a cover plate of a cylindrical battery suitable for high-speed production according to the present disclosure;

FIG. 14 is a schematic structural view of a multi-tab jelly roll of a cylindrical battery suitable for high-speed production according to the present disclosure;

FIG. 15 is a schematic structural view of a full-tab jelly roll of a cylindrical battery suitable for high-speed production according to the present disclosure;

FIG. 16 is a schematic structural view of a cut-and-stacked tab jelly roll of a cylindrical battery suitable for high-speed production according to the present disclosure; and

FIG. 17 is a schematic structural view illustrating that a first current collector and a second current collector are welded to a jelly roll member of a cut-and-stacked tab jelly roll in a cylindrical battery suitable for high-speed production according to the present disclosure.

### REFERENCE NUMERALS

1: case assembly, 101: case, 102: central hole, 103: polar pillar, 104: through hole, 105: step, 106: insulating element, 107: first sealing ring, 108: second sealing ring, 2: jelly roll member, 201: tab, 202: multi-tab jelly roll, 203: full-tab jelly roll, 204: cut-and-stacked tab jelly roll, 3: first current collector, 301: liquid injection hole, 302: first central boss, 303: L-shaped punched hole, 4: second current collector, 401: second central boss, 402: flange, 5: cover plate, 501: locating step, 502: explosion-proof snick, and 6: blind rivet.

### DETAILED DESCRIPTION OF THE EMBODIMENTS

In order to enable those of ordinary skill in the art to better understand the present disclosure, the technical solutions of the present disclosure will be further described below with reference to the accompanying drawings and embodiments.

In the present disclosure, the serial numbers such as “first” and “second” are merely used to distinguish the described objects, and do not have any order or technical meaning. In the present disclosure, unless otherwise stated, “connection” and “link” include direct and indirect connection. It should be understood that orientations or position relationships indicated by terms “longitudinal”, “transverse”, “upper”, “lower”, “front”, “rear”, “left”, “right”, “vertical”, “horizontal”, “top”, “bottom”, “inside”, “outside”, and the like are based on the orientation or position relationships shown in the accompanying drawings. These terms are just used to facilitate the description of the present disclosure and simplify the description, but not to indicate or imply that the mentioned device or elements must have a specific orientation and must be established and operated in a specific orientation, and thus these terms cannot be understood as a limitation to the present disclosure.

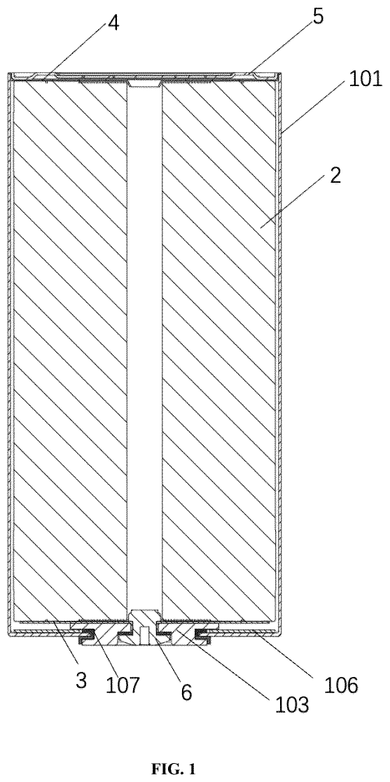

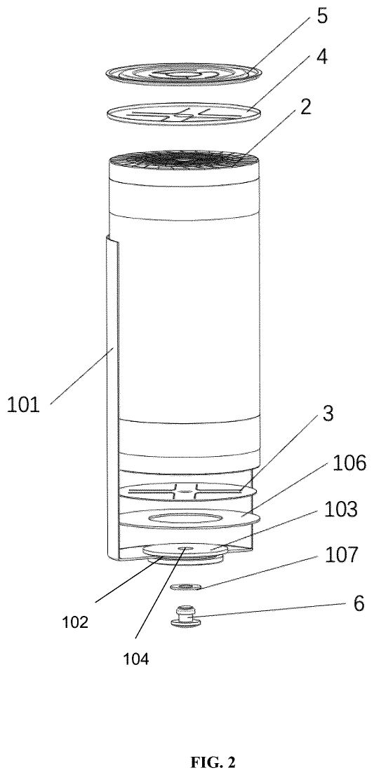

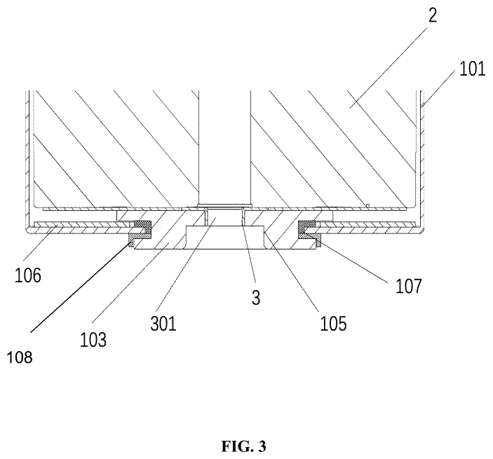

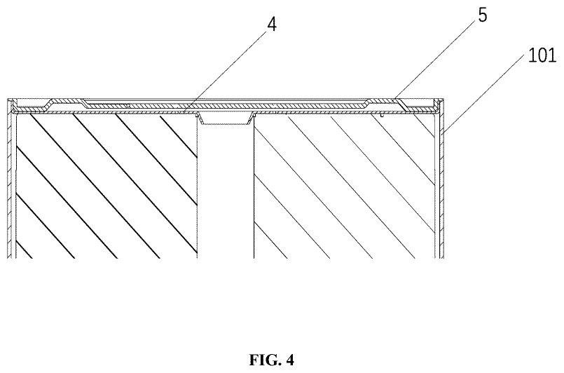

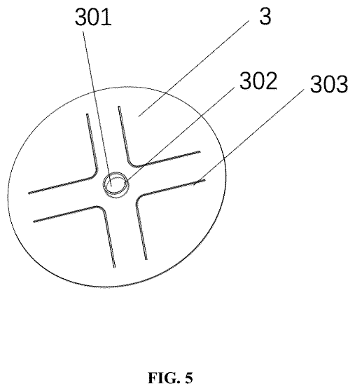

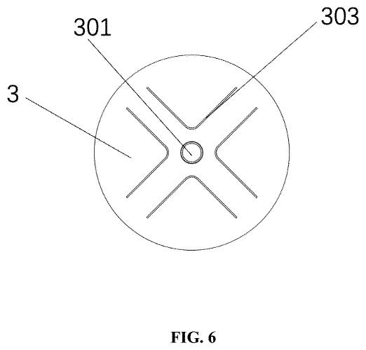

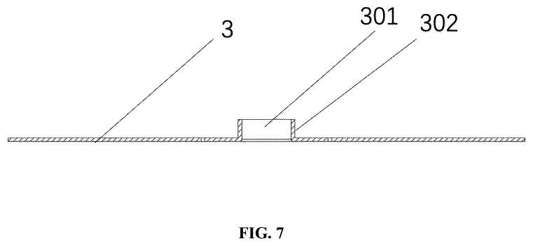

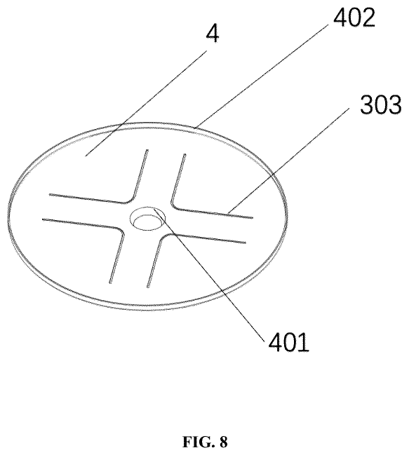

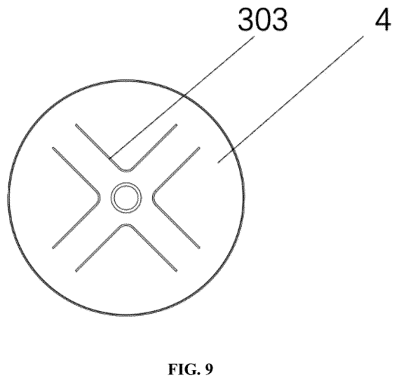

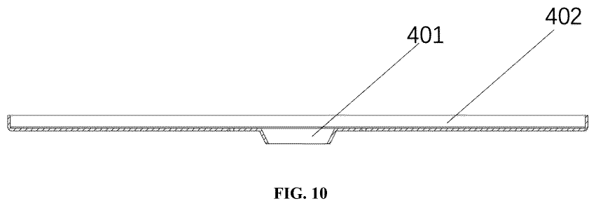

As shown in FIGS. 1-10, a cylindrical battery suitable for high-speed production includes a case assembly 1. The case assembly 1 includes a case 101. The case 101 is a U-shaped structure. A jelly roll member 2 is provided in the case 101. Two ends of the jelly roll member 2 are respectively provided with tabs 201. The tab 201 at one end of the jelly roll member 2 is welded with a first current collector 3. The tab 201 at the other end of the jelly roll member 2 is welded with a second current collector 4. The first current collector 3 is closely attached to a bottom end of the U-shaped structure of the case 101. The second current collector 4 is provided at an opening of the U-shaped structure of the case 101. A side of the second current collector 4 away from the jelly roll member 2 is provided with a cover plate 5. The second current collector 4 is welded with the case 101 and the cover plate 5 to form an integrated structure. A liquid injection hole 301 is formed in a center of a surface of the first current collector 3. Four L-shaped punched holes 303 are formed around the liquid injection hole 301. A first central boss 302 is provided around the liquid injection hole 301. A second central boss 401 is provided at a center of a surface of the second current collector 4. Another four L-shaped punched holes 303 are formed around the second central boss 401. A flange 402 in an opposite direction to the second central boss 401 is provided at an edge of the second current collector 4. The liquid injection hole 301 is mainly configured to facilitate location of the first current collector 3 with a polar pillar 103 in a central hole 102, and realize electrical connection through pressing of a blind rivet 6. Meanwhile, the liquid injection hole 301 also serves as a hole for injecting an electrolyte.

An end of the case 101 closely attached to the first current collector 3 is provided with the central hole 102. The polar pillar 103 is provided in the central hole 102. The polar pillar 103 penetrates through the central hole 102. A through hole 104 is formed in a center of the polar pillar 103. A step 105 is provided in the through hole 104. An insulating element 106 is provided between the polar pillar 103 and the case 101. A first sealing ring 107 is provided between the insulating element 106 and the polar pillar 103. A second sealing ring 108 is provided between the first sealing ring 107 and an end of the polar pillar 103 away from the insulating element 106. The first current collector 3 is provided with the first central boss 302 and the liquid injection hole 301, and the through hole 104 is formed in the polar pillar 103, such that the electrolyte is injected conveniently, and the first central boss 302 of the first current collector 3 is connected to the through hole 104 by pull riveting. This sealing manner is simple and efficient.

Preferably, the L-shaped punched holes 303 each include a long edge parallel to a long edge of an adjacent L-shaped punched hole 303, and a short edge parallel to a short edge of another adjacent L-shaped punched hole 303. An included angle between two edges of the L-shaped punched hole 303 around the liquid injection hole 301 points to the liquid injection hole 301. An included angle between two edges of the L-shaped punched hole 303 around the locating through hole 104 points to the locating through hole 104. The L-shaped punched hole 303 is mainly configured to adapt to heights after the first current collector 3 and the second current collector 4 are respectively welded with the tabs 201 of the cell, absorb the electrolyte, and eliminate a height tolerance of the jelly roll member 2. Bottoms of the four L-shaped punched holes 303 enclose a weak conductive area. In response to an excessive external current, the weak conductive area is fused, thereby improving safety of the core.

Preferably, the second central boss 401 is a tapered structure. The second central boss 401 is inserted into a central hole 102 of the jelly roll member 2. An outer side of the flange 402 of the second current collector 4 is attached to an inner wall of the case 101 and the cover plate 5 and formed into an integrated structure with the inner wall of the case and the cover plate by vertical laser welding. This improves welding efficiency. The second central boss 401 is mainly inserted into the jelly roll member 2 for location.

Preferably, the liquid injection hole 301 of the first current collector 3 is sealed by the blind rivet 6. The polar pillar 103 is fixed on the case 101 through the blind rivet 6. The polar pillar 103 is provided with the through hole 104, and employs a combined connection sealing structure of the sealing rings 107 and 108 and the blind rivet 6. The blind rivet 6 makes the first central boss 302 of the first current collector 3 closely attached to an edge of the through hole 104 to realize electrical connection, and further prevents poor welding for the electrolyte residue in welding using the liquid injection sealing pin, thereby improving a sealing pass rate.

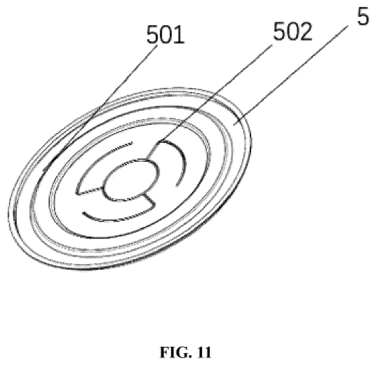

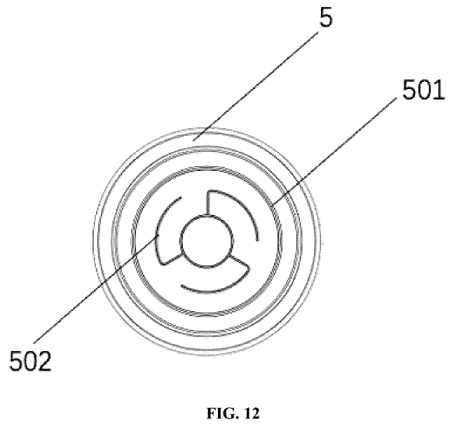

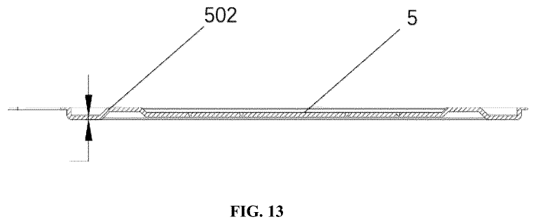

As shown in FIGS. 11-13, the locating step 501 is provided at an axial edge of a surface of the cover plate 5. A periphery of the cover plate 5 lapped with the case 101 is thinned. A thinned thickness of the periphery of the cover plate is 0.5 times an original thickness of the periphery of the cover plate. An explosion-proof snick formed by combining a circular hole with three trailing shapes is provided at a center of the cover plate 5. Through the thinned design at the periphery of the cover plate 5 for cooperating with the current collector and the case, the cover plate 5, the current collector and the case can be welded together with less laser welding energy to realize sealing and electrical connection. This omits one welding process. The vertical galvanometric laser circumferential welding has higher efficiency than the side-rotating circumferential welding. This lowers the cost, improves the efficiency, reduces the laser welding energy and the welding defect, and improves the welding yield. With the explosion-proof snick of the cover plate 5, in response to a failure of the cell, a valve is opened conveniently, and a height required to open the valve is reduced.

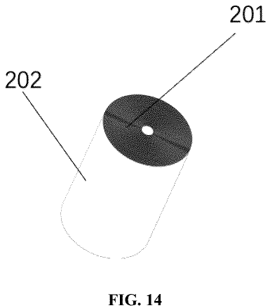

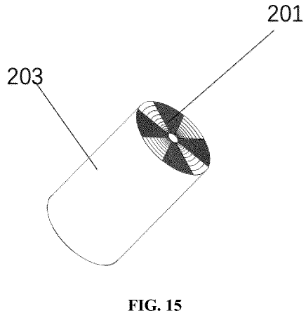

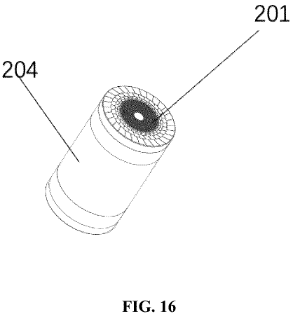

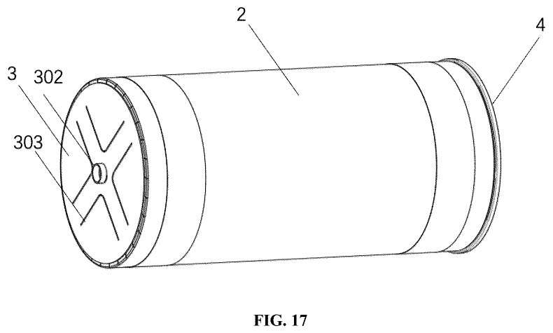

As shown in FIGS. 14-17, the jelly roll member is one of a multi-tab jelly roll, a full-tab jelly roll, and a cut-and-stacked tab jelly roll.

Preferably, the sealing rings 107 and 108 are made of a rubber material. The scaling rings 107 and 108 made of the rubber material has desirable scaling performance within an operating pressure range and a certain temperature range, and can automatically improve the sealing performance as a pressure increases. These scaling rings have a stable coefficient of friction, strong resistance to corrosion, a simple structure, convenient use and maintenance, and a longer service life.

An assembly process of the cylindrical battery suitable for high-speed production includes the following steps:

In step S1, the tabs 201 of the wound jelly roll member 2 are shaped, such that the tabs 201 on the jelly roll member 2 are closely attached in a planar state.

In step S2, the tabs 201 of the jelly roll member 2 are respectively welded with the first current collector 3 and the second current collector 4 by laser.

In step S3, a welded structure is inserted into the case 101 from the opening of the case 101.

In step S4, the cover plate 5 is pressed at the opening of the case 101 for the vertical laser welding, and the cover plate 5, the second current collector 4 and the case 101 are sealed together by melting, thereby forming electrical connection.

In step S5, liquid injection is performed through the central hole 102 and the liquid injection hole 301.

In step S6, the sealing rings 107 and 108 is mounted on the polar pillar 103. Pull riveting is performed with the blind rivet 6 for sealing.

In assembly, the tabs 201 of the jelly roll member 2 are respectively welded with the first current collector 3 and the second current collector 4. The second central boss 401 of the second current collector 4 is located on the jelly roll member 2, and welded. The jelly roll member 2, the first current collector 3 and the second current collector 4 are mounted from the opening of the U-shaped structure of the case 101. The first central boss 302 of the first current collector 3 is clamped accurately into the through hole 104 of the polar pillar 103. The cover plate 5 is provided and pressed. An outer ring of the flange 402 of the second current collector 4 is attached to an inner ring of the case 101 and a portion of the cover plate 5 lapped on the case 101 for vertical laser circumferential welding. The liquid injection is performed on the jelly roll member 2 through the liquid injection hole 301 and the through hole 104. Upon completion of the liquid injection, the blind rivet 6 is inserted into the liquid injection hole 301. The pull riveting is performed with a tool, until a core in the blind rivet 6 is pulled out. The rivet at the liquid injection hole 301 expands horizontally to seal the liquid injection hole 301. The polar pillar 103 is also fixed on the case 101 by the pull riveting, thereby ensuring the overall scaling.

The above are merely the embodiments of the present disclosure. Common knowledge such as well-known specific structures and characteristics in the solution are not detailed herein. Those skilled in the art know all the common technical knowledge in the technical field to which the present disclosure belongs before the filing date or the priority date, and have the ability to apply conventional experimental means before the date. Those skilled in the art can improve and implement this solution in combination with their own abilities under the inspiration given in present disclosure. Some typical well-known structures or well-known methods should not be an obstacle for those skilled in the art to practice the present disclosure. It should be noted that those skilled in the art may further make several variations and improvements without departing from the scope of the present disclosure, but such variations and improvements should also be deemed as falling within the protection scope of the present disclosure without affecting the implementation effect and practicability of the patent.

What is claimed is:

1. A cylindrical battery suitable for high-speed production, comprising a case assembly, wherein the case assembly comprises a case; the case is a U-shaped structure; a jelly roll member is provided in the case; two ends of the jelly roll member are respectively provided with tabs; a tab at one end of the jelly roll member is welded with a first current collector; a tab at another end of the jelly roll member is welded with a second current collector; the first current collector is closely attached to a bottom end of the U-shaped structure of the case; the second current collector is provided at an opening of the U-shaped structure of the case; a side of the second current collector away from the jelly roll member is provided with a cover plate; and the second current collector is welded with the case and the cover plate to form an integrated structure; and
a liquid injection hole is formed in a center of a surface of the first current collector; first four L-shaped punched holes are formed around the liquid injection hole; a first central boss is provided around the liquid injection hole; a second central boss is provided at a center of a surface of the second current collector; second four L-shaped punched holes are formed around the second central boss; and a flange in an opposite direction to the second central boss is provided at an edge of the second current collector.

2. The cylindrical battery according to claim 1, wherein an end of the case closely attached to the first current collector is provided with a central hole; a polar pillar is provided in the central hole; the polar pillar penetrates through the central hole; a through hole is formed in a center of the polar pillar; a step is provided in the through hole; an insulating element is provided between the polar pillar and the case; a first sealing ring is provided between the insulating element and the polar pillar; and a second sealing ring is provided between the first sealing ring and an end of the polar pillar away from the insulating element.

3. The cylindrical battery according to claim 1, wherein the first and second four L-shaped punched holes each comprise a long edge parallel to a long edge of an adjacent L-shaped punched hole, and a short edge parallel to a short edge of another adjacent L-shaped punched hole; an included angle between two edges of each of the first four L-shaped punched holes points to the liquid injection hole; and an included angle between two edges of each of the second four L-shaped punched holes points to the second central boss.

4. The cylindrical battery according to claim 1, wherein the second central boss is a tapered structure; the second central boss is configured to be inserted into a central hole of the jelly roll member; and an outer side of the flange of the second current collector is attached to an inner wall of the case and the cover plate and formed into the integrated structure with the inner wall of the case and the cover plate by vertical laser welding.

5. The cylindrical battery according to claim 1, wherein the liquid injection hole of the first current collector is sealed by a blind rivet; and the polar pillar is fixed on the case through the blind rivet.

6. The cylindrical battery according to claim 1, wherein a locating step is provided at an axial edge of a surface of the cover plate; a periphery of the cover plate lapped with the case is thinned; a thinned thickness of the periphery of the cover plate is 0.5 times an original thickness of the periphery of the cover plate; and an explosion-proof snick formed by combining a circular hole with three trailing shapes is provided at a center of the cover plate.

7. The cylindrical battery according to claim 1, wherein the jelly roll member is one of a multi-tab jelly roll, a full-tab jelly roll, and a cut-and-stacked-tab jelly roll.

8. The cylindrical battery according to claim 2, wherein the first and second sealing rings are made of a rubber material.

9. An assembly process of the cylindrical battery according to claim 1, comprising the following steps:
S1, shaping the tabs of the wound jelly roll member, such that the tabs on the jelly roll member are closely attached in a planar state;
S2, respectively welding the tabs of the jelly roll member with the first current collector and the second current collector by laser to form a welded structure;
S3, inserting the welded structure into the case from the opening of the case;
S4, pressing the cover plate at the opening of the case for the vertical laser welding, and sealing the cover plate, the second current collector and the case together by melting, thereby forming electrical connection;
S5, performing liquid injection through the central hole and the liquid injection hole; and
S6, mounting a sealing ring on the polar pillar, and performing pull riveting with a blind rivet for sealing.
